(19) United States
(12) Patent Application Publication
(10) Pub. No.: US 2026/0254231 A1
(43) Pub. Date: Aug. 27, 2026

(54) Optically Isolated Power-Over-Fiber System

(71) Applicant: PMK Mess- und Kommunikationstechnik, GmbH, Bad Soden Am Taunus (DE)

(72) Inventors: Jurij Weber, Schwalbach Am Taunus (DE); Mark Heimann, Bad Soden Am Taunus (DE); Michael J. Mende, Portland, OR (US); Juergen Trueller, Gernheim (DE); Kai Klein, Neu Anspach (DE); Richard Booman, Lake Oswego, OR (US); Alessandro Saverio Passarelli, Frankfurt am Main (DE); Felix Wenk, Bad Soden am Taunus (DE); Philipp Palffy, Bad Soden Am Taunus (DE)

(21) Appl. No.: 19/547,660

(22) Filed: Feb. 23, 2026

Related U.S. Application Data
(60) Provisional application No. 63/761,876, filed on Feb. 21, 2025.

(51) Int. Cl. H02J 1/00

(52) U.S. Cl. CPC H02J 1/00

(57) ABSTRACT

A power-over-fiber system includes a proximal laser module, a distal power module, and a fiber-optic cable bundle. The proximal module converts electrical energy into photon energy and transmits the photon energy through the fiber bundle. The distal module converts the photon energy into electrical energy and supplies isolated power to a load. The distal module includes a bulk energy storage device enabling delivery of high-peak currents. Sensor data transmitted through communication fibers allows the proximal module to regulate laser output and implement safety mechanisms. The system provides isolated, dynamically regulated power suitable for high-voltage applications.

### CROSS REFERENCE TO RELATED APPLICATION

This application claims priority to U.S. provisional application number 63/761,876 entitled Optically Isolated Power-Over-Fiber System for High Dynamic Current Loads in High Voltage Applications, and having a filing date of Feb. 21, 2025. The entire contents are incorporated herein by reference.

### FIELD OF THE DISCLOSURE

The present disclosure relates to power-over-fiber (“POF”) systems, particularly an optically isolated power delivery system providing power to a galvanically isolated load.

The disclosure applies to test and measurement instrumentation for applications requiring high common-mode voltage capabilities, such as high-side V_{GS} measurements in GaN and SiC systems.

### BACKGROUND OF THE DISCLOSURE

The development of modern circuitry in power electronics requires profound understanding of transient signal behavior, such as signal edges during on-off switching events, which are often triggered using double-pulse tests. In power electronics applications, there is a clear trend towards higher voltage levels, often exceeding several thousands of volts. Measuring small voltage ripples and fast signal artifacts during switching events requires advanced probing technologies with sophisticated shielding, a sufficiently high bandwidth, often exceeding 1 GHz, and a very high common-mode voltage such as ±60 kV or more. Such common-mode voltage capability allows attenuating the probe's sensitivity specifically to the fluctuating component of the signal, whilst cancelling out its common mode voltage component, or DC bias.

Achieving high common-mode capable probes requires operating them at a galvanic isolation, which means the absence of any ground loops formed from the probe head to the environment ground, such as mains. One of the key challenges is powering the probe in a manner that maintains the galvanic isolation integrity even for elevated power demands.

POF is a promising technology for power delivery whilst maintaining galvanic isolation, as it uses fiber optics and provides immunity to electromagnetic interference (EMI) and offers reliable power delivery over long distances (>10 m). However, current POF solutions are limited in their ability to deliver high peak currents needed for dynamic loads and often lack advanced power management for stable power output, energy saving, and edge-case management for user convenience.

Accordingly, there is a need for a novel POF system that overcomes these limitations while maintaining compatibility with high-voltage, EMI-sensitive, and safety-critical applications. There exists a need for an improved interface system that addresses these and other shortcomings by offering a low-cost, versatile, and effective shielded adapter solution for electronic testing and signal transmission.

### SUMMARY OF THE DISCLOSURE

What is needed is a modular, isolated POF system that can maintain a stable energy supply, adapt to dynamic and continuous power demands, trickle charge without overcharging an energy storage unit, and release excess energy as heat without manually controlling a laser diode of the POF system. The POF system maintains compatibility with high-voltage, EMI-sensitive, and safety-critical applications by delivering high-peak currents needed for dynamic loads, providing intelligent power management for stable power output, and ensuring safety mechanisms such as rapid shutdown in the event of fiber failure.

### BRIEF DESCRIPTION OF THE DRAWINGS

The accompanying drawings that are incorporated in and constitute a part of this specification illustrate several embodiments of the disclosure. Together with the description, they serve to explain the principles of the disclosure.

FIG. 1 illustrates an exemplary POF system including a proximal laser module, a distal power module, and a fiber-optic cable. The distal module is shown inserted into an existing battery compartment of a probe head.

FIG. 2 illustrates an exemplary schematic of the proximal and distal modules, including the power laser, adjustable current-source driver, optical power converter, bulk storage device, and communication paths.

FIG. 3 illustrates an exemplary power over fiber system with the distal module sliding into a probe head battery compartment and connecting to a proximal module via a fiber-optic cable.

FIG. 4 illustrates an exemplary adapter configuration for powering a galvanically isolated differential probe using the POF system.

FIG. 5 illustrates an exemplary system with proximal module, distal module, and probe head.

FIG. 6 illustrates an exemplary system with a power supply unit, a proximal module, and a distal module.

### NUMERALS OF THE FIGURES

1. POF System
3. LED status light
5. Power switch
7. Power connection interface
9. Laser power sensor
11. Laser diode
13. Photodiode
15. Load power sensor
17. Received load sensor
19. Proximal module
20. Distal module
21. Optical fiber bundle
22. Optical fiber connection
23. Galvanic isolation barrier
25. Power transmission optical fiber
27. Communication optical fiber
29. Input
31. Output
33. Power supply unit
35. Power cable
37. Bulk energy storage device
39. Probe head
41. Battery compartment
43. Optical power converter
45. Power conversion
47. Power module power supply and communication
49. Laser module power supply and communication
51. Power laser
53. Current source driver
55. Power module
57. Laser module

### DETAILED DESCRIPTION

The present disclosure relates to an optically isolated power-over-fiber system configured to deliver electrical power across high-voltage differentials while maintaining complete galvanic isolation between a proximal module and a distal module. The system may be designed to support both continuous and highly dynamic peak current loads, which may include transient power demands that exceed the continuous optical power throughput capability of the fiber. The architecture may incorporate a laser-based optical power transmitter, a photovoltaic-based optical power receiver, a bulk energy storage device, and a bidirectional communication interface that enables real-time monitoring, intelligent power regulation, and multi-layer safety mechanisms. The system may be suitable for high-voltage test and measurement probes, electric vehicle systems, industrial automation equipment, and aerospace electronics, where electrical isolation, EMI immunity, and stable power delivery are essential.

The system includes a proximal module, or base module, or laser module, that converts electrical energy into photon energy and injects the photon energy into one or more optical fibers. The proximal module may contain an electrical input interface, a power supply, a microcontroller or processor, a laser diode or laser diode array, and a current-source driver configured to regulate the laser output. The proximal module may include a power switch, status indicators, and mechanical features for integration with external power supplies or test equipment. A transmitted-power sensor may be provided within the proximal module and may be capable of measuring the instantaneous current and voltage supplied to the laser diode. These values may be used by the processor to compute the transmitted optical power and to adjust the laser drive current based on feedback received from the distal module.

The distal module, or load module, may receive photon energy through the fiber-optic cable bundle and convert it into electrical energy using an optical power converter such as a photovoltaic cell or photodiode array. The distal module may include a bulk energy storage device, such as a rechargeable battery, supercapacitor, or hybrid storage element, that accumulates energy over time and releases it during short-duration peak loads. This configuration enables the distal module to supply peak currents comparable to those of a standalone 18650 battery, even when the continuous optical power throughput of the fiber is lower. The distal module may further include a receiving-power sensor that measures the electrical output of the optical power converter and a load-power sensor that measures the electrical power delivered to the external load. Both sensors may measure instantaneous current and voltage and transmit these values to the proximal module through dedicated communication fibers. The distal module may be packaged in a form factor compatible with existing battery-powered devices, such as a tubular housing shaped like a standard 18650 battery, enabling drop-in replacement for battery-powered differential probes without modification to the probe housing.

The fiber-optic cable bundle connecting the proximal and distal modules may include at least one high-power optical fiber for transmitting laser power and at least one optical fiber for transmitting sensor data and control signals. The fibers may be bundled within a protective jacket, and the cable length may range from approximately 2.3 meters to 2.5 meters for compatibility with test and measurement setups. The fiber-optic cable bundle may comprise a protective coating. The protective jacket and the protective coating may include opaque properties to protect stray light exiting the fibers from exiting to the outside. The fiber-optic cable bundle provides complete galvanic isolation between the modules, enabling the distal module to float at voltages that may differ by tens of kilovolts from the proximal module. In some embodiments, the system maintains isolation up to ±60 kV common-mode voltage.

The system has a control system. The control system may incorporate a first, a second, and a third sensor. The sensor may be a transmitted-power sensor located in the proximal module, a received-power sensor located in the distal module, and a load-power sensor also located in the distal module. Each sensor may measure instantaneous current and voltage. Each sensor may include a current shunt and a resistor. The sensors may not compute power; instead, they may transmit raw current and voltage values to the proximal module. The proximal module may compute transmitted power, received power, and load power by multiplying the respective current and voltage values, received from the associated sensor. This real-time computation enables the proximal module to maintain a complete model of the power path, establish a representation of energy levels across the system in real-time, and to regulate the laser output accordingly.

The proximal module may execute software that continuously evaluates the three power measurements and adjusts the laser drive current to match the load requirements. When the load demands power, the proximal module increases the laser output to supply the required energy. When the load demand is low or zero, the proximal module reduces or disables the laser output to conserve energy and prevent unnecessary optical power transmission. When the load demands short bursts of high current, the distal bulk storage device supplies the transient energy, and the proximal module replenishes the storage device over time. The control logic may be implemented using a finite-state machine, a proportional-integral-derivative controller, or other algorithmic structures that regulate the laser output based on sensor feedback.

The control system may include multiple independent safety mechanisms. A power-logic safety layer may compare transmitted, received, and load power values to detect abnormal conditions such as overpower situations, unexpected current flow patterns, or discrepancies between transmitted and received power that exceed expected optical losses. A communication-integrity safety layer may disable the laser if the proximal module does not receive valid sensor data from the distal module within a defined time window. A thermal safety layer may be provided and may comprise at least one temperature sensor. In one embodiment, the thermal safety layer may comprise two temperature sensors that are located in the proximal and/or distal modules. The thermal safety layer may be configured to reduce or interrupt laser output if overheating is detected in one or more thermal sensors. These safety layers may operate independently and may be combined to diagnose and react to complex fault conditions.

In one embodiment, the distal module is inserted into the battery compartment of a high-voltage differential probe. The probe receives isolated electrical power from the distal module while maintaining full galvanic isolation from the proximal module and the test equipment. This configuration eliminates battery-related downtime and ensures consistent measurement performance during long-duration testing. The system may also be integrated into production line testing environments, where continuous operation of galvanically isolated devices is required.

Alternative embodiments may include different laser wavelengths or power levels, different optical converter technologies, different bulk storage capacities, different communication protocols, or different mechanical form factors. Additional sensors such as humidity sensors, vibration sensors, or fiber-bend sensors may be incorporated to enhance system reliability. The modules may be integrated into a single housing, distributed across multiple housings, or embedded within existing equipment.

In the following sections, detailed descriptions of examples and methods of the disclosure will be given. The description of both preferred and alternative examples is exemplary only, and it is understood that to those skilled in the art that variations, modifications, and alterations may be apparent. It is therefore to be understood that the examples do not limit the broadness of the aspects of the underlying disclosure as defined by the claims.

### Detailed Descriptions of the Drawings

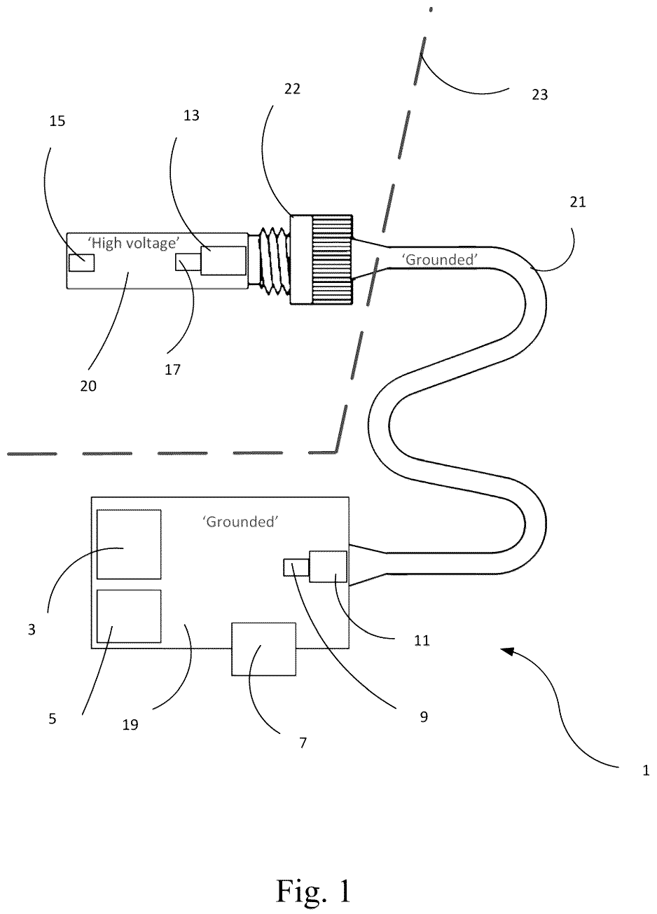

Referring to FIG. 1, a power over fiber system is shown. The power over fiber (“POF”) system, POF system, has a proximal end and a distal end, each with a POF module. Proximal and distal modules are connected by a fiber-optic cable. The proximal module, also called base module or laser module, is configured to convert electrical energy into photon energy. The distal module, also called floating module or load module, is configured to convert photon energy back into electrical energy. Within the scope of this disclosure, the term ‘electrical energy’ means electricity flowing through a conductor. The term ‘photon energy’ means energy in the form of light waves or light radiation. The term ‘galvanic isolation’ can be understood fulfilled, if a common mode voltage of +−60 kV is achieved. The term ‘floating’ refers to a component inside the perimeter of galvanic isolation, meaning not forming a ground loop with its surroundings.

The POF system is configured such that it ensures a complete galvanic isolation of the distal module, such that it is floating. This can be achieved by manufacturing the fiber-optic cable, and any other component physically connecting proximal and distal modules, of materials that are electric isolators such as plastic. The advantage of such a POF system is that it can be used to power any consumer of energy which should not, or must not, for a ground loop with the environment. An example are high-end test and measurement probes used to measure small differential voltages, when a measurement ‘relative to ground’ would result in excessive common-mode error, loss of measurement fidelity, or unsafe operating conditions. Since any typical wire-connection would result in unacceptable measurement error or violate the common-mode voltage limits, batteries are often used as ground-loop free power sources. However, batteries are a limited power source, which is often a problem, especially in test and measurement applications with long-term campaigns, when high probe availability is crucial, or in integrated test benches where probes are fixedly installed and hard to access. A POF system according to the present disclosure combines the galvanic isolation known from the use of batteries with the availability and reliability of a classic conductive connection lead.

The proximal module may or may not be galvanically isolated. It may be partially galvanically isolated. The proximal module may comprise a power connection interface for connection with an external electrical power source, such as an external power supply, for example an adapter, a socket, a cable, a lemo-type plug or socket, or the like.

The proximal module may comprise a power switch. The proximal module may comprise an LED status light, indicating whether it is powered on or not. The proximal module comprises means to convert electrical energy into photon energy, for example a laser diode. The proximal module comprises an interface for injecting the photon energy into the fiber-optic cable. Such means might be an in-coupling laser diode.

The distal module comprises a photodiode to convert photon energy back into electrical energy. The distal module comprises an electrical connection, outputting electrical energy that was received as photon energy and converted to electrical energy. The distal module may comprise a tubular portion in the shape of a battery, to mimic the form-factor of a standard battery. The distal module may comprise a handle for screwing and unscrewing the distal module into a power consumption device such as a galvanically isolated probe.

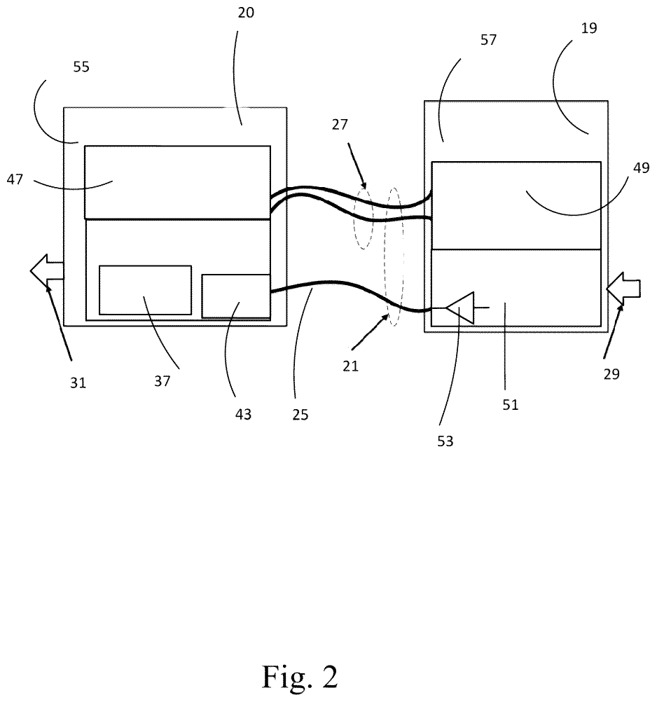

Referring to FIG. 2, a schematic of the POF system is shown by two blocks, which are arranged side-by-side and connected by three lines. The left-hand block represents the distal module, called the POF Power Module (PM). The right-hand block represents the proximal module, called the POF Laser Module (LM). The PM block comprises an output, outputting galvanically isolated electrical power, which is indicated by the arrow pointing to the left. The LM block comprises an input, consuming electrical power from an electrical power source. The term ‘galvanically isolated electrical power’ refers to electrical power provided inside the galvanically isolated perimeter. Hence, a consumer inside the galvanically isolated perimeter may consume said power without breaking through said perimeter.

The proximal module, the LM block, comprises a power laser and adjustable current source driver, as well as a power supply/uC/communication/support Ckts. The power laser and adjustable current source driver is used to convert the consumed electrical power into photon energy and to inject the photon energy into a power-carrying optical fiber, which is represented by the lowermost line which connects LM and PM modules. The power supply/uC/communication/support Ckts may be used to inject or receive information signals into or from dedicated optical fibers, which are represented by the second and third lines connecting LM and PM modules. These two fiber-optic cables form a communication path (Rx/Tx). All three fiber-optic cables may be bundled into one fiber-optic cable or conglomerate of cables.

The distal module, the PM block, comprises a power conversion element, and a power supply/μC/communication/support Ckts, which is complementary to its counterpart of the LM block. The power conversion element consumes the photon energy from the power-carrying fiber and converts it into electrical energy. The power conversion element may further comprise a bulk storage device. This bulk storage device is configured to store electrical energy coming from the optical power converter. This bulk storage device may be trickle chargeable. It can be a battery, super cap, etc. The presence of this bulk storage device acts as energy storage. With such a device, it is possible to temporarily output an amount of energy from the PM block which is greater than the maximum power throughput of the fiber-optical cable. This is extremely valuable for applications that require short bursts of high energy, for example to control a temperature-controlled TEC stack or the like. Contrary to the existing prejudice in the industry, the POF according to the present disclosure is no longer limited by the power-throughput capability of the fiber-optic cable. Instead, much higher power demands can be fulfilled with the added bulk storage device. Specifically, the distal module can be designed such that it provides bursts of energy with a similar performance that can be achieved with a single 18650 type battery.

In one embodiment, the distal module may comprise a current shunt, an analog-to-distal converter, and microcontroller μC, and a return light source, and the proximal module may comprise a communication photodiode. In the distal module, measured I and V values may be digitized and sent as data by modulating the return light source. This data may then be consumed in the proximal module using the communication photodiode. The return light source may be a low-power laser/LED.

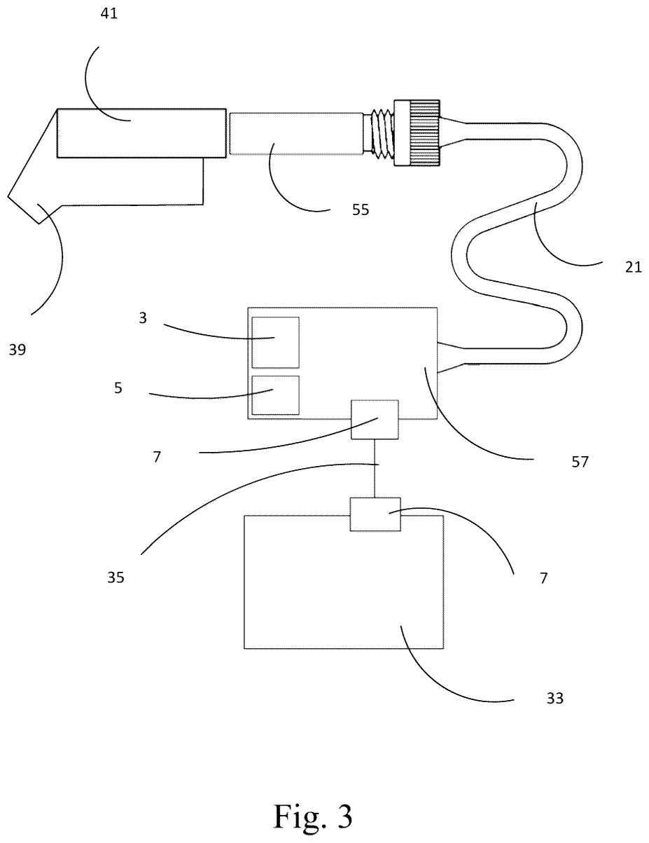

Referring to FIG. 3, a POF system is shown in combination with a probe head and a power supply. The probe head comprises a battery compartment. The distal POF module is configured to slide into the battery compartment when the battery is removed from it. Once inserted, the distal POF module can be screwed onto the battery compartment, such that an electrical connection between the distal POF module and the probe head is established. When the distal POF module outputs power, it powers the probe head. Since the distal POF module is galvanically isolated from the proximal POF module, it can power the probe head while maintaining galvanic isolation.

The fiber-optical cable between the proximal and the distal module may have a length of 2.3 m to 2.5 m. The proximal module may be connected to an external power supply through a power cable. The power cable can have lemo-type ends. The power supply may or may not have an interface for data and control signal transmission. For example, signals for remote controlling the power supply and/or the proximal module.

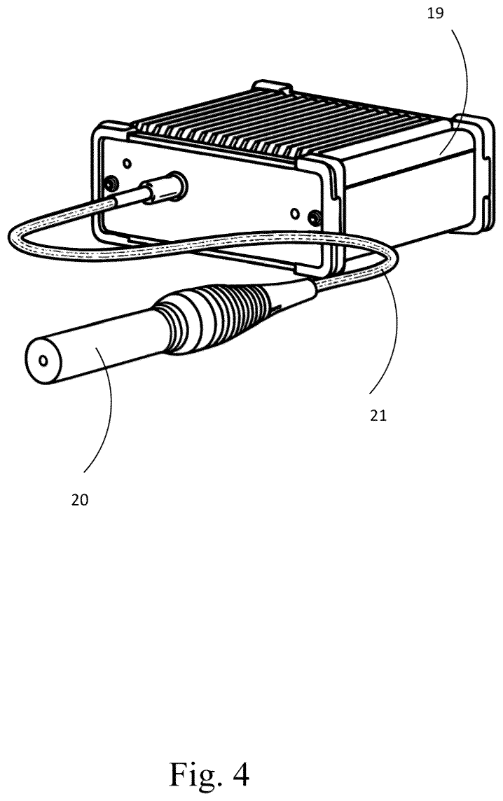

The configuration shown in FIG. 4 is ideal for production line testing and automation, as it enables continuous operation of galvanically isolated power consuming devices, for example, a test and measurement probe. It is also retrofittable to existing power consuming devices using a battery. The POF system may be configured such that the distal module comprises a tubular portion with the dimensions of an 18650 type battery.

Referring to FIG. 4, a POF system is shown in a perspective view. The shown embodiment of the POF system may be used to power a galvanically isolated differential probe head for high-voltage, high-bandwidth test and measurement applications.

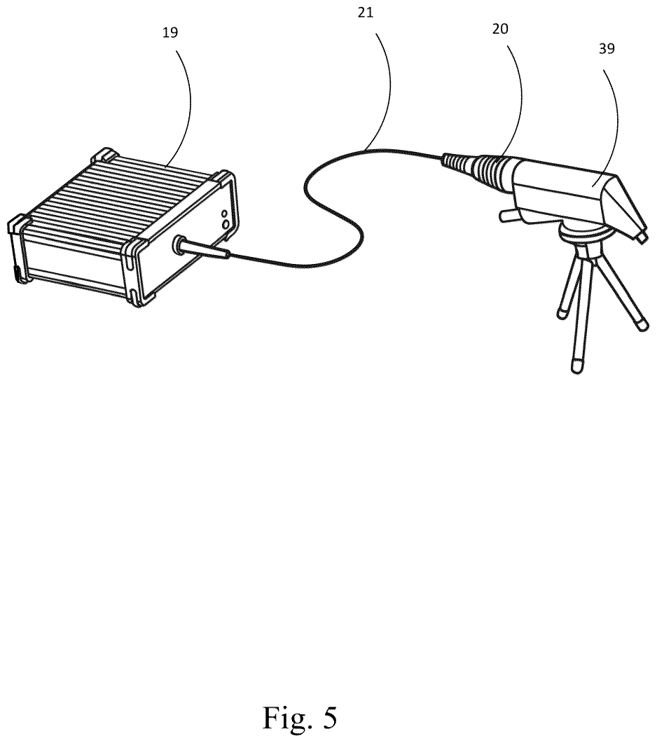

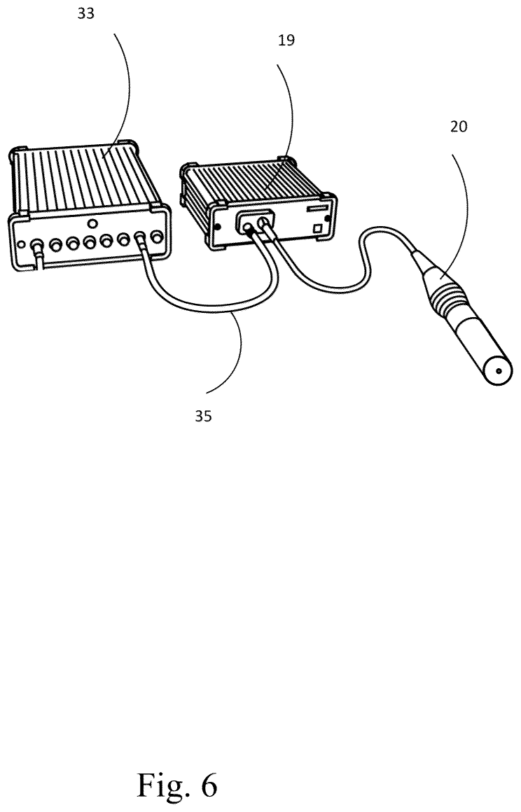

Referring to FIGS. 5 and 6, the system is shown in use with either a probe head or a power supply unit, respectively.

### CONCLUSION

A number of embodiments of the present disclosure have been described. While this specification contains many specific implementation details, these details should not be construed as limitations on the scope of any disclosures or of what may be claimed.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A power-over-fiber system comprising:
a proximal module configured to generate photon energy and inject the photon energy into at least one optical fiber;
a distal module configured to receive the photon energy through the at least one optical fiber and provide electrical power to a load;
a fiber-optic link providing galvanic isolation between the proximal module and the distal module; and
a control system comprising a first sensor, a second sensor, and a third sensor configured to regulate the photon energy based on information received from the distal module.

2. The system of claim 1, wherein the distal module comprises an energy-storage element configured to supply peak electrical power to the load.

3. The system of claim 1, wherein the fiber-optic link comprises at least one power transmission optical fiber and at least one communication optical fiber.

4. The system of claim 1, wherein the fiber-optic link maintains galvanic isolation across a common-mode voltage difference of at least tens of kilovolts.

5. The system of claim 1, wherein the control system is configured to adjust the photon energy in response to operating conditions of the load.

6. The system of claim 1, further comprising wherein the control system is configured to detect abnormal operating conditions and modify the photon energy in response.

7. The system of claim 6, wherein the abnormal operating conditions comprise discrepancies between power transmitted to the distal module and power delivered to the load.

8. The system of claim 6, wherein the abnormal operating conditions comprise loss of communication between the proximal module and the distal module.

9. The system of claim 6, wherein the abnormal operating conditions comprise a temperature condition at the proximal module or at the distal module.

10. The system of claim 1, wherein the distal module is configured to be installed in place of a battery in a battery-powered device.

11. The system of claim 1, wherein the proximal module is configured to receive electrical power from a power supply unit.
